(19) United States
(12) Patent Application Publication
(10) Pub. No.: US 2018/0357975 A1
(43) Pub. Date: Dec. 13, 2018

(54) DISPLAY DEVICE

(71) Applicant: Sharp Kabushiki Kaisha, Sakai City, Osaka (JP)

(72) Inventors: Takuya SONE, Sakai City (JP); Tatsuhiko SUYAMA, Sakai City (JP); Noriyuki TANAKA, Sakai City (JP); Kentaroh UEMURA, Sakai City (JP)

(21) Appl. No.: 16/061,059

(22) PCT Filed: Jan. 20, 2017
(86) PCT No.: PCT/JP2017/001938

§ 371 Date: Jun. 11, 2018

(30) Foreign Application Priority Data
Jan. 28, 2016 (JP) 2016-013971

(51) Int. Cl. G09G 3/36

(52) U.S. Cl. CPC G09G 3/3677; G09G 3/3688; G09G 2320/0247; G09G 2300/0842; G09G 2320/041; G09G 2320/0271; G09G 2330/021

(57) ABSTRACT

Provided is a display device which makes less flicker perceived in transition from a pause period to a drive period by suppressing image luminance from changing.

Regardless of whether the number of pause frames in an immediately preceding pause period is high, or whether there is an image change immediately after a transition from the pause period to a drive period, high-speed scans are performed from Operating Frame One through Operating Frame Three, and BC drive is performed during Operating Frames One and Two. As a result, image luminance change immediately after the transition from the pause period to the drive period can be suppressed in a short period of time, and therefore, the occurrence of flicker as perceived by the viewer can be suppressed. Moreover, high-speed scans are performed only from Operating Frame One through Operating Frame Three, and therefore, power consumption in a liquid crystal display device 1 can be reduced.

### TECHNICAL FIELD

The present invention relates to display devices, particularly to a liquid crystal display device capable of pause drive.

### BACKGROUND ART

Recent years have seen active development of compact and lightweight electronic devices. Liquid crystal display devices provided in such electronic devices are required to be of low power consumption type. One drive method which reduces power consumption in liquid crystal display devices is a drive method called “pause drive” wherein a drive period, during which a video is displayed by writing a voltage of an image signal based on image data (referred to below as an “image signal voltage”) by means of the scanning of scanning signal lines, is followed by a pause period, during which the writing is paused by rendering all scanning signal lines inactive. In pause drive, no control signals and suchlike are provided to a gate driver and a source driver during the pause period, so that the operation of the gate driver and the source driver is paused, resulting in reduced power consumption. In the case where pause drive is performed, to prevent liquid crystals from deteriorating due to continuous application of a direct-current voltage, the image signal voltage is applied with the polarity being inverted during a drive period immediately following the pause period. At this time, image luminance decreases significantly, with the result that flicker is more likely to be perceived.

Patent Document 1 describes that in transition from the pause period to the drive period, when the number of pause frames immediately preceding the transition is greater than or equal to a predetermined value, boost-charge drive, in which a boost-charge voltage higher than the image signal voltage is applied (referred to below as “BC drive” or “gradation value emphasizing drive”), and drive in which the image signal voltage is applied (referred to below as “normal drive”) are performed in succession, and thereafter, normal drive is performed only once. As a result, power consumption during pause drive can be reduced.

### CITATION LIST

### Patent Document

Patent Document 1: International Publication WO 2014/103918

### SUMMARY OF THE INVENTION

### Problems to be Solved by the Invention

However, in transition from the pause period to the drive period, even if boost-charge drive and normal drive are performed in succession, as in Patent Document 1, the decrease of image luminance is not sufficiently inhibited, resulting in a problem where flicker is perceived.

Therefore, an objective of the present invention is to provide a display device which makes less flicker perceived in transition from a pause period to a drive period by suppressing image luminance from changing.

### Solution to the Problems

A first aspect of the present invention is directed to a display device capable of pause drive, the device comprising:

a display panel having formed thereon a plurality of scanning signal lines, a plurality of data signal lines, each crossing the scanning signal lines, and a plurality of pixel forming portions arranged in a matrix corresponding to intersections of the scanning signal lines and the data signal lines;

a signal line driver circuit configured to sequentially select the scanning signal lines and write an image signal voltage to the data signal lines, the image signal voltage being generated on the basis of externally inputted image data; and

a display control circuit configured to control an operation of the signal line driver circuit and including a correction circuit configured to correct the image data, wherein,

the correction circuit includes:
a pause/operating frame distinguishing circuit configured to output either an operating frame detection signal upon detection of an operating frame or a pause frame detection signal upon detection of a pause frame;
a high-speed scanning portion capable of writing at a second speed higher than a first speed at which the image signal voltage obtained on the basis of the image data is written to the pixel forming portion; and
a gradation value emphasizing drive portion configured to obtain corrected image data by correcting the image data using either a first correction value or a second correction value and thereby render gradation value emphasizing drive possible,

the correction circuit generates first corrected image data during a first operating frame immediately after a transition from a pause period during which the pause drive is performed and a drive period during which normal drive is performed, the first corrected image data being obtained through a correction using the first correction value by activating the high-speed scanning portion and the gradation value emphasizing drive portion,

the correction circuit generates second corrected image data during a second operating frame consisting of one or more frames following the first operating frame, the second corrected image data being obtained through a correction using the second correction value by activating the gradation value emphasizing drive portion and the high-speed scanning portion, and

the signal line driver circuit writes a first gradation value emphasizing voltage generated on the basis of the first corrected image data to the pixel forming portion during the first operating frame and a second gradation value emphasizing voltage generated on the basis of the second corrected image data to the pixel forming portion during the second operating frame.

In a second aspect of the present invention, based on the first aspect of the present invention, wherein the image signal voltage based on the image data is written to the pixel forming portion at the second speed during a third operating frame following the second operating frame, by activating only the high-speed scanning portion.

In a third aspect of the present invention, based on the first aspect of the present invention, wherein,

the gradation value emphasizing drive portion includes an adder-subtracter circuit configured to correct the image data using the first correction value or the second correction value, and

the adder-subtracter circuit obtains the first corrected image data by adding or subtracting the first correction value to or from the image data or obtains the second corrected image data by adding or subtracting the second correction value to or from the image data.

In a fourth aspect of the present invention, based on the first aspect of the present invention, wherein,

the second correction value is lower than the first correction value,

the gradation value emphasizing drive portion includes an adder-subtracter circuit configured to correct the image data using the first correction value or the second correction value, and

the adder-subtracter circuit obtains the first corrected image data by adding the first correction value to the image data and obtains the second corrected image data by adding the second correction value to the image data.

In a fifth aspect of the present invention, based on the third aspect of the present invention, wherein,

the high-speed scanning portion includes frame memory configured to hold the externally inputted image data,

the gradation value emphasizing drive portion further includes:
an operating frame number counter circuit having a first counter configured to count the number of operating frames upon each provision of an operating frame detection signal from the pause/operating frame distinguishing circuit, the operating frame number counter circuit being configured to output a table selection signal in accordance with a count value of the first counter; and
a correction value output circuit having a first table and a second table and configured to select either the first table or the second table in accordance with the count value provided by the operating frame number counter circuit and provide an output to the adder-subtracter circuit, and

the operating frame number counter circuit outputs the table selection signal to select the first table when the count value of the first counter is “1” and does not output the table selection signal when the count value of the first counter is greater than or equal to 3 but outputs the table selection signal to select the second table when the count value is greater than “1”, but less than, equal to, or greater than 3.

In a sixth aspect of the present invention, based on the fifth aspect of the present invention, wherein the count value of the first counter is reset by a pause frame detection signal outputted by the pause/operating frame distinguishing circuit.

In a seventh aspect of the present invention, based on the fifth or sixth aspect of the present invention, wherein,

the high-speed scanning portion further includes:
a pause frame number counter circuit having a second counter configured to count the number of operating frames upon each provision of a pause frame detection signal from the pause/operating frame distinguishing circuit; and
a scan speed determination circuit configured to cause the frame memory to output the image data at the second speed,

the pause frame number counter circuit outputs a high-speed-scan enable signal to the scan speed determination circuit and a table enable signal to the correction value output circuit when a count value of the second counter reaches a predetermined value, the high-speed-scan enable signal rendering possible the outputting of the image data from the frame memory at the second speed, the table enable signal rendering possible the selecting of the first table or the second table,

the scan speed determination circuit outputs a high-speed-scan signal to the frame memory so as to cause the frame memory to output the image data to the adder-subtracter circuit at the second speed, and

upon provision of the table selection signal from the operating frame number counter circuit, the correction value output circuit is allowed to select either the first table or the second table in accordance with the table selection signal.

In an eighth aspect of the present invention, based on the seventh aspect of the present invention, wherein the count value of the second counter is reset by an operating frame detection signal outputted by the pause/operating frame distinguishing circuit.

In a ninth aspect of the present invention, based on the fifth or sixth aspect of the present invention, wherein,

the high-speed scanning portion further includes:
an image comparison circuit configured to determine by a checksum value whether an image represented by the externally inputted image data is the same as an image represented by image data externally inputted immediately before the externally inputted image data; and
a scan speed determination circuit configured to cause the frame memory to output the image data at the second speed,

the image comparison circuit has a checksum circuit configured to obtain the checksum value and outputs a high-speed-scan enable signal to the scan speed determination circuit and a table enable signal to the correction value output circuit when a checksum value of externally inputted image data equals a checksum value of image data for an image displayed immediately before the externally inputted image data is provided,

the scan speed determination circuit outputs a high-speed-scan signal to the frame memory so as to allow the frame memory to output the image data to the adder-subtracter circuit at the second speed, and

upon provision of the table selection signal from the operating frame number counter circuit, the correction value output circuit is allowed to select either the first table or the second table.

In a tenth aspect of the present invention, based on the seventh or eighth aspect of the present invention, wherein,

the high-speed scanning portion further includes an image comparison circuit configured to determine by a checksum value whether an image represented by the externally inputted image data is the same as an image represented by image data externally inputted immediately before the externally inputted image data is provided,

the image comparison circuit has a checksum circuit configured to obtain the checksum value and outputs a high-speed-scan enable signal to the scan speed determination circuit and a table enable signal to the correction value output circuit when a checksum value of externally inputted image data equals a checksum value of image data for an image displayed immediately before the externally inputted image data is provided,

upon provision of the high-speed-scan enable signal from each of the pause frame number counter circuit and the image comparison circuit, the scan speed determination circuit outputs a high-speed-scan signal to the frame memory so as to allow the frame memory to output the image data to the adder-subtracter circuit at the second speed, and

upon provision of the high-speed-scan enable signal from each of the pause frame number counter circuit and the image comparison circuit, the correction value output circuit is allowed to select the first table or the second table in accordance with the table selection signal.

In an eleventh aspect of the present invention, based on the first aspect of the present invention, wherein,

the high-speed scanning portion further includes:
frame memory configured to hold the externally inputted image data;
a temperature sensor circuit configured to measure a temperature of the display panel;
a scan speed determination circuit configured to scan the operating frame at a speed higher than the first speed in accordance with the temperature measured by the temperature sensor circuit; and
an adder-subtracter circuit configured to add or subtract a correction value to or from the image data,

the gradation value emphasizing drive portion further includes a correction value output circuit configured to select a table from among a plurality of tables containing correction values for the image data and provide an output to the adder-subtracter circuit, and

the temperature sensor circuit outputs temperature information to the scan speed determination circuit and a table enable signal to the correction value output circuit, the temperature information indicating the temperature of the display panel, the table enable signal renders the selecting of the table possible.

In a twelfth aspect of the present invention, based on the first aspect of the present invention, wherein,

the pixel forming portion includes:
a liquid crystal capacitor configured to hold the image signal voltage; and
a switching element with a control terminal connected to the scanning signal line, a first conductive terminal connected to the data signal line, and a second conductive terminal connected to the liquid crystal capacitor, and
the switching element is a thin-film transistor with a channel layer formed with an oxide semiconductor.

In a thirteenth aspect of the present invention, based on the twelfth aspect of the present invention, wherein the thin-film transistor is a channel-etched thin-film transistor.

In a fourteenth aspect of the present invention, based on the thirteenth aspect of the present invention, wherein the oxide semiconductor is indium gallium zinc oxide.

In a fifteenth aspect of the present invention, based on the fourteenth aspect of the present invention, wherein the oxide semiconductor is a crystalline oxide semiconductor.

### Effect of the Invention

In the first aspect, during the first operating frame immediately after the transition from the pause period to the drive period, the high-speed scanning portion and the gradation value emphasizing drive portion are activated, whereby the first corrected image data is generated by correcting the image data using the first correction value, and during the second operating frame, the second corrected image data is generated by correcting the image data using the second correction value. On the basis of the corrected image data, the gradation value emphasizing voltages are obtained and written to the pixel forming portion at the second speed higher than the first speed at which the image signal voltage is written. Thus, image luminance change immediately after the transition from the pause period to the drive period can be suppressed in a short period of time, and therefore, the occurrence of flicker as perceived by the viewer is suppressed. In this case, the first and second gradation value emphasizing voltages are written at the second speed until image luminance returns to the original level, and thereafter, the image signal voltage is written at the first speed, with the result that power consumption in the display device can be reduced.

In the second aspect, during the third operating frame, only the high-speed scanning portion is activated, whereby the image signal voltage is written to the pixel forming portion at the second speed. Thus, the luminance of an image to be displayed can be adjusted to a level originally represented by image data in a short period of time.

In the third aspect, image luminance is set higher than a level originally represented by image data during the first operating frame but lower than a level originally represented by image data during the second operating frame. Thus, any change in the luminance of an image displayed after a transition to a drive period can be suppressed in a short period of time.

In the fourth aspect, the correction value for image data to be used decreases in descending order of the operating frame. Thus, the luminance of an image to be displayed can be adjusted to a level originally represented by the image data in a short period of time.

In the fifth aspect, regardless of whether the number of pause frames in the pause period is high, or whether an image during an operating frame immediately after the transition to the drive period is the same as an image displayed during the pause period immediately before the transition, BC drive and a high-speed scan are performed for each operating frame. As a result, image luminance change immediately after the transition from the pause period to the drive period can be suppressed in a short period of time, and therefore, the occurrence of flicker as perceived by the viewer can be suppressed.

In the sixth aspect, the count value of the first counter provided in the operating frame number counter circuit is reset by the pause frame detection signal outputted by the pause/operating frame distinguishing circuit. As a result, upon each transition from a pause period to a drive period, the count value of the first counter is reset so as to count the number of operating frames, with the result that it is rendered possible to determine whether to perform gradation value emphasizing drive and/or a high-speed scan on the basis of the count value and also possible to select a correction value when gradation value emphasizing drive is performed.

In the seventh aspect, only when the number of pause frames in a pause period is greater than the predetermined value, gradation value emphasizing drive and a high-speed scan are performed for each operating frame in an immediately following drive period. In the case of a transition from a pause period consisting of a number of pause frames to an operating period, image luminance change is perceptible, and in such a case, such image luminance change is required to be suppressed. Therefore, only when the number of pause frames is greater than the predetermined value, gradation value emphasizing drive and a high-speed scan are performed for each operating frame. Thus, image luminance change immediately after the transition from the pause period to the drive period can be suppressed in a short period of time, and therefore, the occurrence of flicker as perceived by the viewer can be suppressed.

In the eighth aspect, the count value of the second counter provided in the pause frame number counter circuit is reset by the operating frame detection signal outputted by the pause/operating frame distinguishing circuit. As a result, upon each transition from a pause period to a drive period, the count value of the second counter is reset, with the result that it is rendered possible to determine whether to perform gradation value emphasizing drive and/or a high-speed scan on the basis of the number of pause frames counted for each pause period.

In the ninth aspect, checksum values obtained by the checksum circuit provided in the image comparison circuit are compared so as to determine whether an image to be displayed immediately after a transition from a pause period to a drive period is the same as an image displayed during the pause period immediately before the transition. The reason for such a determination is that a luminance change during an operating frame is perceptible when the images are the same, but such a luminance change is not perceptible when there is an image change. Therefore, when the images are determined to be the same, gradation value emphasizing drive and a high-speed scan are performed for each operating frame, whereby image luminance change immediately after the transition from the pause period to the drive period can be suppressed in a short period of time. Thus, the occurrence of flicker as perceived by the viewer can be suppressed.

The tenth aspect includes the pause frame number counter circuit of the seventh aspect and the image comparison circuit of the ninth aspect. Accordingly, in the case where the number of pause frames is greater than the predetermined value and the image to be displayed immediately after the transition from the pause period to the drive period is the same as the image displayed during the pause period immediately before the transition, gradation value emphasizing drive and a high-speed scan are performed for each operating frame. Thus, image luminance change can be suppressed in a short period of time, and the occurrence of flicker as perceived by the viewer can be suppressed.

In the eleventh aspect, by taking advantage of the response speed of the liquid crystal depending on the temperature, a high-speed scan is performed during the operating frame at the speed higher than the first speed, in accordance with the temperature of the liquid crystal layer of the pixel forming portion, which is measured by the temperature sensor circuit provided on the display panel, and the table enable signal, which allows the selection of a table, is provided to the correction value output circuit, with the result that a correction value is outputted to the adder-subtracter circuit. Accordingly, when the temperature of the liquid crystal is high, a high-speed scan and gradation value emphasizing drive are performed, whereby image luminance change immediately after the transition from the pause period to the drive period is suppressed in a short period of time. Thus, the occurrence of flicker as perceived by the viewer can be suppressed.

In any of the twelfth through fifteenth aspects, the thin-film transistor that is used as the switching element of each pixel forming portion has a channel layer formed with an oxide semiconductor. As a result, the thin-film transistor offers significantly reduced off-leakage current, and a voltage written in the pixel capacitor of the pixel forming portion is held for a longer period of time. Thus, the occurrence of flicker in transition from the pause period to the drive period can be suppressed.

### BRIEF DESCRIPTION OF THE DRAWINGS

FIG. 1 is a block diagram illustrating the configuration of a liquid crystal display device according to a first embodiment of the present invention.

FIG. 2 is a block diagram illustrating the configuration of a correction circuit provided in a display control circuit of the liquid crystal display device shown in FIG. 1.

FIG. 3 provides diagrams showing examples of gradation values and correction values held in first and second LUTs of a correction value output circuit provided in the correction circuit shown in FIG. 2 where part (A) is a diagram showing examples of the gradation values and the correction values held in the first LUT, and part (B) is a diagram showing examples of the gradation values and the correction values held in the second LUT.

FIG. 4 is a graph showing gradation values for corrected image data obtained using the first and second LUTs shown in FIGS. 3(A) and 3(B).

FIG. 5 is a diagram showing an example of a change in image luminance where neither a high-speed scan nor BC drive is performed.

FIG. 6 is a diagram illustrating an example of a change in image luminance where BC drive is performed alone.

FIG. 7 is a diagram illustrating an example of a change in image luminance where high-speed scans and BC drive are performed.

FIG. 8 is a diagram illustrating an example of a change of a voltage applied to a liquid crystal layer of a pixel forming portion by a drive method according to a first variant of the first embodiment.

FIG. 9 is a diagram illustrating an example of a change of a voltage applied to the liquid crystal layer of the pixel forming portion by a drive method according to a second variant of the first embodiment.

FIG. 10 is a block diagram illustrating the configuration of a correction circuit included in a display control circuit of a liquid crystal display device according to a second embodiment.

FIG. 11 is a block diagram illustrating the configuration of a correction circuit included in a display control circuit of a liquid crystal display device according to a variant of the second embodiment.

FIG. 12 is a diagram illustrating an example of a change of a voltage applied to a liquid crystal layer of a pixel forming portion by a drive method of a variant of the second embodiment.

FIG. 13 is a block diagram illustrating the configuration of a correction circuit included in a display control circuit of a liquid crystal display device according to a third embodiment.

FIG. 14 is a block diagram illustrating the configuration of a correction circuit included in a display control circuit of a liquid crystal display device according to a variant of the third embodiment.

FIG. 15 is a block diagram illustrating the configuration of a correction circuit included in a display control circuit of a liquid crystal display device according to a fourth embodiment.

FIG. 16 is a diagram illustrating the structure of a channel-etched TFT.

### MODES FOR CARRYING OUT THE INVENTION

### 1. First Embodiment

<1.1 Configuration and General Operation of the Liquid Crystal Display Device>

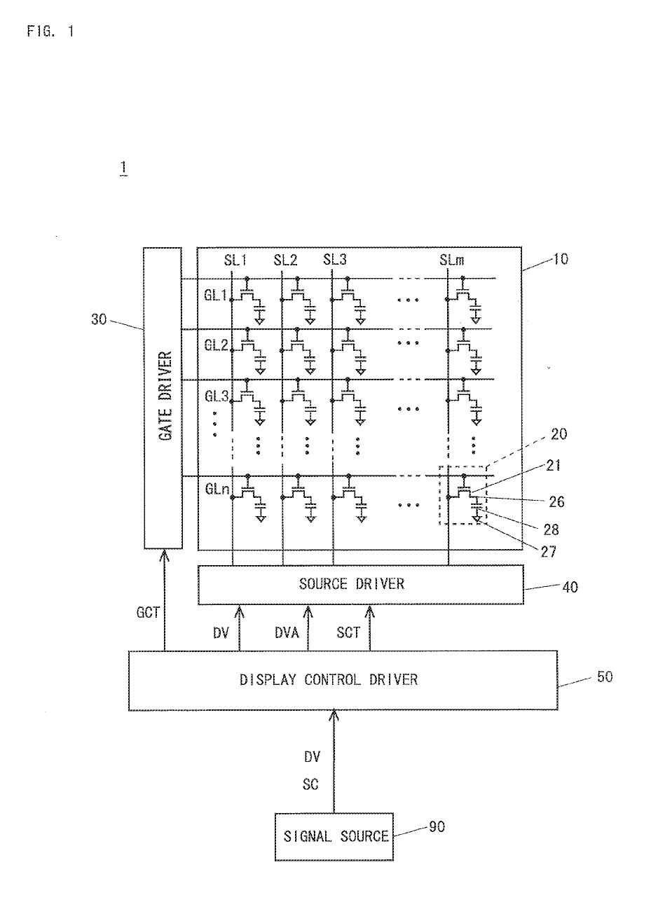

FIG. 1 is a block diagram illustrating the configuration of a liquid crystal display device 1 according to a first embodiment of the present invention. As shown in FIG. 1, the liquid crystal display device 1 includes a liquid crystal display panel 10, a gate driver 30, which serves as a scanning signal line driver portion, a source driver 40, which serves as a data signal line driver portion, and a display control circuit 50, which serves as a display control portion.

The liquid crystal display panel 10 has formed thereon m source lines SL1 to SLm, which serve as video signal lines, n gate lines GL1 to GLn, which serve as scanning signal lines, and (m×n) pixel forming portions 20 arranged in a matrix corresponding to respective intersections of the source lines SL1 to SLm and the gate lines GL1 to GLn. Each pixel forming portion 20 includes a TFT 21, which has a gate terminal serving as a control terminal and connected to the gate line GL passing through a corresponding intersection and a source terminal serving as a first conductive terminal and connected to the source line SL passing through the intersection, a pixel electrode 26 connected to a drain terminal of the TFT 21, which serves as a second conductive terminal, a common electrode 27 provided in common for the pixel forming portions 20, and an unillustrated liquid crystal layer provided between the pixel electrode 26 and the common electrode 27. The pixel electrode 26 and the common electrode 27, along with the liquid crystal layer provided therebetween, constitute a liquid crystal capacitor 28.

Furthermore, the TFT 21 is a TFT whose channel layer may be made with amorphous silicon, polysilicon, or an oxide semiconductor. However, given that the TFT is used in the liquid crystal display device 1 capable of pause drive, off-leakage current is preferably low, and therefore, the TFT with the channel layer (semiconductor layer) made with an oxide semiconductor is most suitable. Therefore, the TFT with the channel layer (semiconductor layer) made with an oxide semiconductor will be described in detail later.

When image data DV, which represents an image to be displayed, and a control signal SC, which includes, for example, a vertical synchronization signal and a horizontal synchronization signal, are inputted from an external signal source 90, the display control circuit 50 generates a source driver control signal SCT, a gate driver control signal GCT, etc., in accordance with the control signal SC. The source driver control signal SCT is provided to the source driver 40, and the gate driver control signal GCT is provided to the gate driver 30. Note that the gate driver 30 and the source driver 40 will also be referred to collectively as the “signal line driver circuit”.

The display control circuit 50 has a correction circuit (not shown) provided therein for correcting the image data DV in order to perform BC drive (also referred to as “gradation value emphasizing drive”) and controlling scan speed in displaying an image on the liquid crystal display panel 10. The correction circuit outputs the image data DV, or corrected image data DVA obtained by correcting the image data DV, to the source driver 40. The configuration and the operation of the correction circuit will be described in detail later.

The source driver 40 generates and outputs an image signal voltage to be provided to each source line SL, on the basis of the image data DV in accordance with the source driver control signal SCT; the image data DV has a positive or negative polarity depending on whether the data is provided through an unillustrated positive or negative gamma circuit. The source driver control signal SCT includes, for example, a source start pulse signal, a source clock signal, and a latch strobe signal. In accordance with such a source driver control signal SCT, the source driver 40 activates unillustrated internal elements, such as a shift register and a sampling latch circuit, and causes an unillustrated D/A conversion circuit to convert the image data DV to an analog signal, thereby generating an image signal voltage. Moreover, the source driver 40 includes unillustrated amplifiers respectively amplifying positive and negative image signal voltages, and the image signal voltage is outputted to the liquid crystal display panel 10 after being amplified by an amplifier selected in accordance with the polarity thereof. Note that in the present embodiment, not only the image signal voltage generated on the basis of the image data DV but also a boost-charge voltage (referred to below as a “BC voltage” or a “gradation value emphasizing voltage”), which is generated on the basis of a corrected image signal, are applied to each source line SL.

The gate driver 30 repeats applying an active scanning signal to each gate line GL in predetermined cycles, in accordance with the gate driver control signal GCT. The gate driver control signal GCT includes, for example, a gate clock signal and a gate start pulse signal. The gate driver 30 activates unillustrated internal elements, such as a shift register, in accordance with the gate clock signal and the gate start pulse signal, thereby generating the scanning signal.

In this manner, the BC voltage and the image signal voltage are applied sequentially to each source line SL, and the scanning signal is applied to each gate line GL, with the result that the image represented by the image data DV transmitted from the external signal source 90 is displayed on the liquid crystal display panel 10.

<1.2 Configuration and Operation of the Correction Circuit>

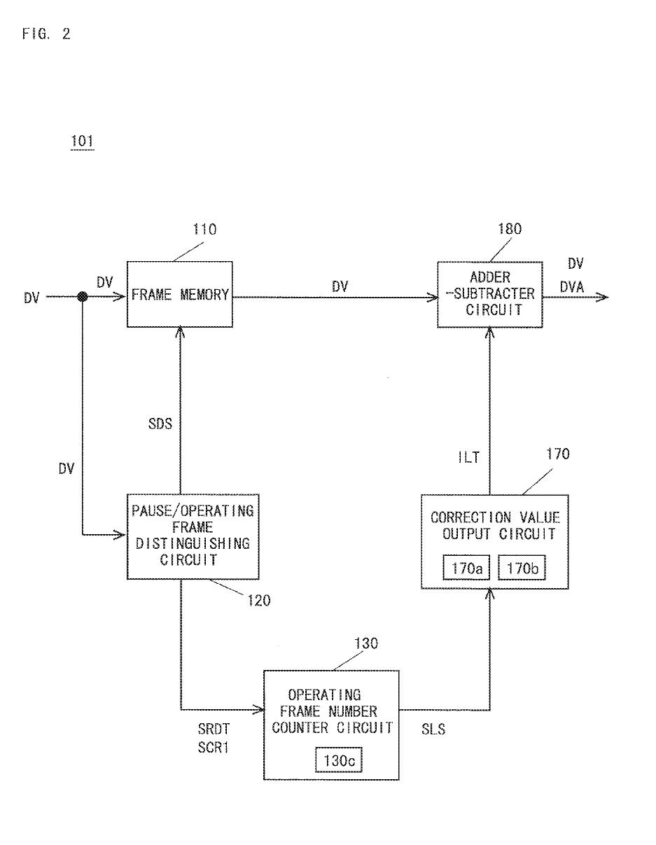

FIG. 2 is a block diagram illustrating the configuration of the correction circuit 101 provided in the display control circuit 50. The correction circuit 101 includes frame memory 110, a pause/operating frame distinguishing circuit 120, an operating frame number counter circuit 130, a correction value output circuit 170, and an adder-subtracter circuit 180, as shown in FIG. 2.

Image data DV, which is inputted from the external signal source 90, is provided to the frame memory 110 and the pause/operating frame distinguishing circuit 120. The frame memory 110, which functions as a memory buffer, is capable of holding previously inputted image data DV for one frame.

The pause/operating frame distinguishing circuit 120 has frame rates for image data DV memorized in an internal register, and upon each provision of image data DV, distinguishes whether the data is for an operating frame (also referred to as a “refresh frame”) or a pause frame (also referred to as a “non-refresh frame”) on the basis of the frame rate for the data. The pause/operating frame distinguishing circuit 120 generates an operating frame detection signal SRDT upon detection of an operating frame, or a count reset signal SCR1 upon detection of a pause frame, and in either case, outputs the generated signal to the operating frame number counter circuit 130.

The operating frame number counter circuit 130 includes a counter 130c (also referred to as a “first counter”), and increments a count value of the counter 130c by 1 upon each provision of an operating frame detection signal SRDT or resets the count value of the counter 130c to “0” upon each provision of a count reset signal SCR1.

The correction value output circuit 170 includes two types of lookup tables (hereinafter, referred to as “LUTs”), a first LUT 170a (also referred to as a “first table”) and a second LUT 170b (also referred to as a “second table”), which have correction values for the image data DV written therein, with a view to correcting a gradation value of an image represented by the image data DV. Whether to select either of these LUTs is determined by an LUT selection signal SLS (also referred to as a “table selection signal”) provided by the operating frame number counter circuit 130. For example, the operating frame number counter circuit 130 generates and outputs an LUT selection signal SLS to the correction value output circuit 170, such that the first LUT 170a is selected when the count value of the counter 130c is “1”, the second LUT 170b is selected when the count value is “2”, or neither of the LUTs is selected when the count value is “3”, as represented by the LUT selection signal SLS.

The pause/operating frame distinguishing circuit 120 outputs a data read start signal SDS to the frame memory 110 upon each detection of an operating frame. Upon provision of the data read start signal SDS, the frame memory 110 starts reading out the image data DV being held therein, and outputs the read-out image data DV to the adder-subtracter circuit 180 at a frame rate of 120 Hz (i.e., 8.3 ms/frame; also referred to as a “second speed”) higher than a normal frame rate of 60 Hz (i.e., 16.6 ms/frame; also referred to as a “first speed”). Note that the pause/operating frame distinguishing circuit 120 differentiates between the operating frame and the pause frame by detecting an image included in the image data DV or on the basis of register settings.

Upon provision of the correction value read out from the selected LUT, either the first LUT 170a or the second LUT 170b, in the correction value output circuit 170, as correction value information ILT, the adder-subtracter circuit 180 outputs corrected image data DVA, which is obtained by correcting the image data DV provided by the frame memory 110 using the correction value information ILT, to the source driver 40, or outputs the image data DV without correction. More specifically, in transition from the pause period to the drive period, the adder-subtracter circuit 180 generates corrected image data DVA by adding a correction value (also referred to as a “first correction value”) read out from the first LUT 170a to image data for Operating Frame One (also referred to as a “first operating frame”), and outputs the corrected image data DVA, whereby BC drive is performed during the operating frame. The adder-subtracter circuit 180 also generates corrected image data DVA by subtracting a correction value (also referred to as a “second correction value”) in the second LUT 170b from image data for Operating Frame Two (also referred to as a “second operating frame”), and outputs the corrected image data DVA, whereby BC drive is performed during the operating frame. Image data DV for Operating Frame Three (also referred to as a “third operating frame”) is outputted without correction, whereby normal drive is performed during the operating frame.

As a result, in transition from the pause period to the normal drive period, regardless of whether the number of pause frames included in the pause period immediately preceding the transition is high, or whether there is any change in an image to be displayed during the drive period compared to an image displayed during the immediately preceding pause period, BC drive and high-speed scans are performed during Operating Frames One and Two, and normal drive and a high-speed scan are performed during Operating Frame Three.

<1.3 BC Drive>

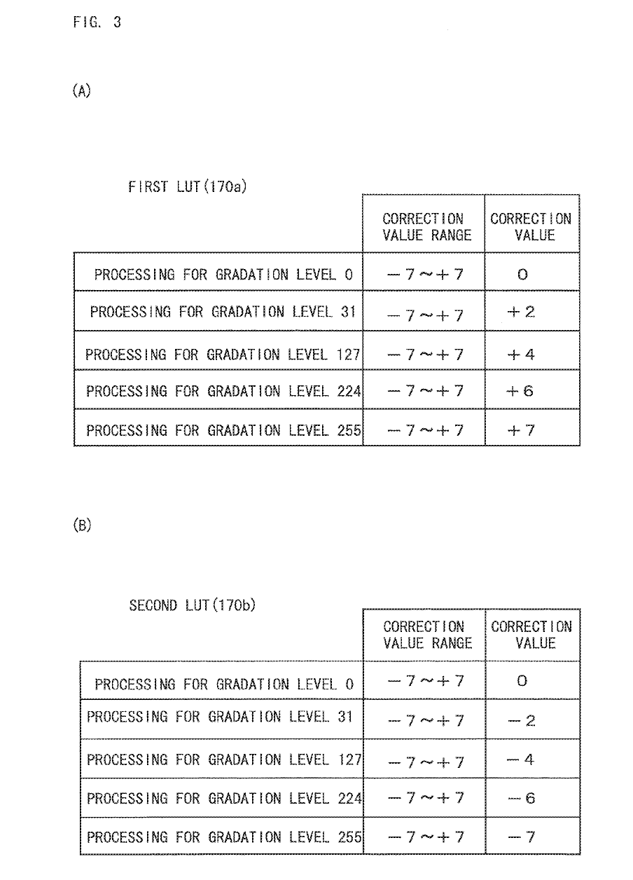

Described now is the correction of the image data DV performed by the correction value output circuit 170 in order to perform BC drive. FIG. 3 provides diagrams showing examples of correction values held in the first and second LUTs 170a and 170b of the correction value output circuit 170, along with examples of the range of the correction values; more specifically, FIG. 3(A) is a diagram showing examples of the correction values in the first LUT 170a and examples of the range of the correction values, and FIG. 3(B) is a diagram showing examples of the correction values in the second LUT 170b and examples of the range of the correction values.

In each of the first and second LUTs 170a and 170b, the correction value is set within the range of from −7 to +7 for each of the following gradation levels from 0 to 255: 0, 31, 127, 224, and 255, as shown in FIGS. 3(A) and 3(B).

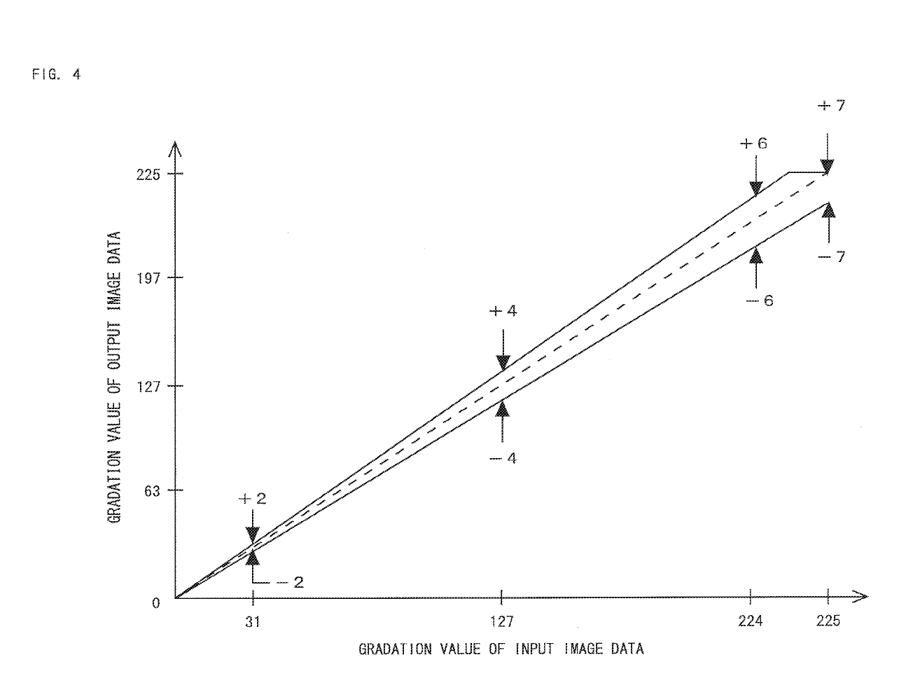

For both of the LUTs 170a and 170b, the correction value is set for each gradation level such that the absolute value of the gradation value increases with the gradation value. FIG. 4 is a graph showing gradation values for corrected image data DVA obtained using the first and second LUTs 170a and 170b shown in FIGS. 3(A) and 3(B). A dotted line shown in FIG. 4 represents the relationship between input and output gradation values where image data DV inputted to the adder-subtracter circuit 180 is outputted without correction. A solid line above the dotted line represents the relationship between the input gradation value and a gradation value for the image data DV obtained by adding a correction value shown in the first LUT 170a to the input gradation value. A solid line below the dotted line represents the relationship between the input gradation value and a gradation value for the image data DV obtained by subtracting a correction value shown in the second LUT 170b from the input gradation value. More specifically, image data for which the input gradation values are 0, 31, 127, 224, and 255 can be corrected using the first LUT 170a, such that gradation values for image data to be outputted are higher than the input gradation value by 0, 2, 4, 6, and 7, respectively. Similarly, the image data for which the input gradation values are 0, 31, 127, 224, and 255 can be corrected using the second LUT 170b, such that gradation values for image data to be outputted are lower than the input gradation value by 0, 2, 4, 6, and 7, respectively. The correction values in the first and second LUTs 170a and 170b are illustrative only, and optimal correction values can be set suitable for corrections.

It should be noted that in the case where the gradation value indicated by the corrected image data obtained by correcting the image data DV using the correction value is negative or greater than 255, the gradation value is treated as 0 or 255, respectively. Moreover, in the case where the gradation value for inputted image data is, for example, within the range of from 1 to 30 or from 32 to 126 and therefore does not correspond to any correction value set in the first and second LUTs 170a and 170b, linear interpolation is applied using a correction value for a range preceding or following that range.

<1.4 Effects by BC Drive and the High-Speed Scan>

Luminance decrease caused upon transition from the pause period to the drive period will be described along with recovery thereafter. FIG. 5 is a diagram showing an example of a change in image luminance where neither BC drive nor a high-speed scan is performed. For each frame in the drive period, the frame rate is 60 Hz (i.e., 16.6 ms). In transition to a drive period immediately following a pause period consisting of three consecutive pause frames, the liquid crystal display device 1 performs normal drive using three consecutive operating frames during which the polarity of image data DV is inverted, as shown in FIG. 5. A retransition to another pause period occurs after Operating Frame Three, and during the pause period, pause drive is performed, with the result that a still image is displayed with an image signal voltage used in Operating Frame Three being held. In this case, image luminance decreases significantly during Operating Frame One, and thereafter slowly returns to the original level indicated by the image data DV, over the course of the subsequent drive period and pause period. Such a luminance change with a significant decrease and a subsequent slow return poses a problem where the viewer perceives flicker.

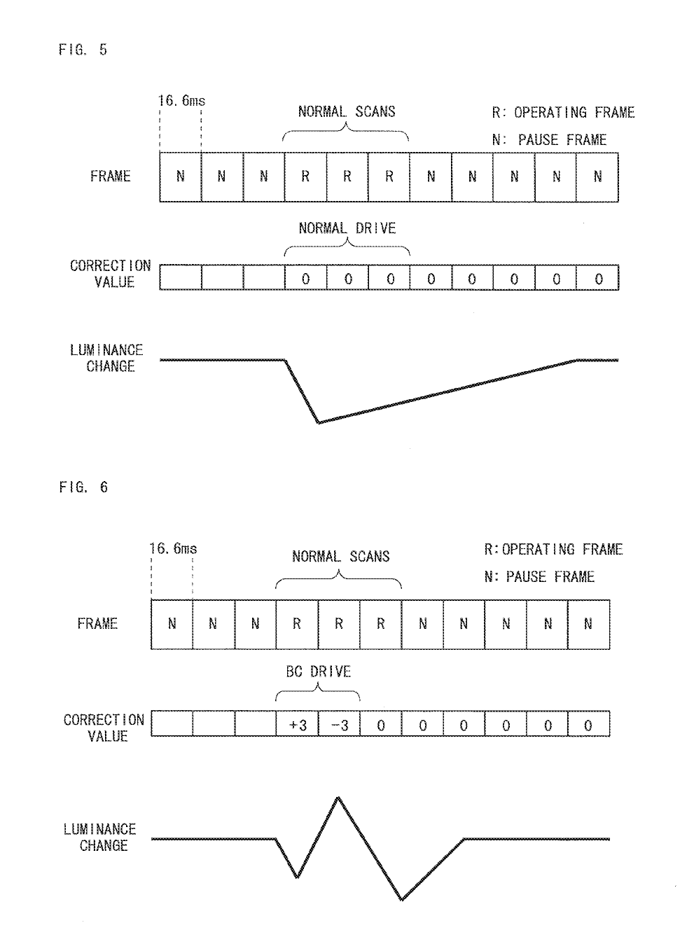

In the next example, BC drive is performed during operating frames using corrected image data DVA obtained by correcting image data DV. FIG. 6 is a diagram illustrating an example of a change in image luminance where BC drive is performed alone. As shown in FIG. 6, BC drive is performed using corrected image data DVA obtained by adding a correction value to image data DV (also referred to as “first corrected image data”) during Operating Frame One and also using corrected image data DVA obtained by, conversely, subtracting a correction value from the image data DV (also referred to as “second corrected image data”) during Operating Frame Two. During Operating Frame Three, the image data DV is outputted without correction. A pause frame follows Operating Frame Three, whereby a transition to a pause period occurs so as to perform pause drive in which a still image is displayed with the image data DV for Operating Frame Three being held. In this case, the time from the start of the initial BC drive until the luminance returns to the original level becomes shorter than in the case shown in FIG. 5. Accordingly, the viewer perceives less flicker than in the case shown in FIG. 5, but some noticeable flicker remains.

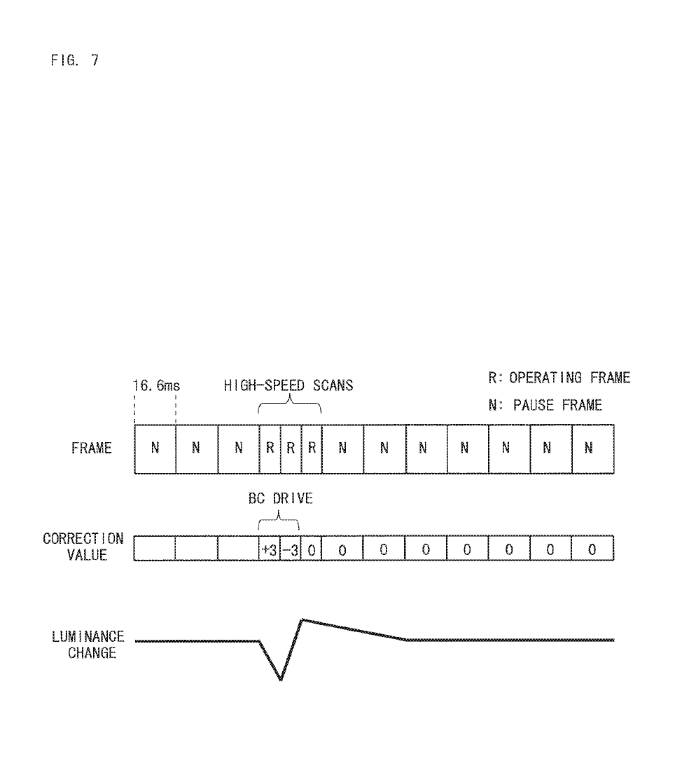

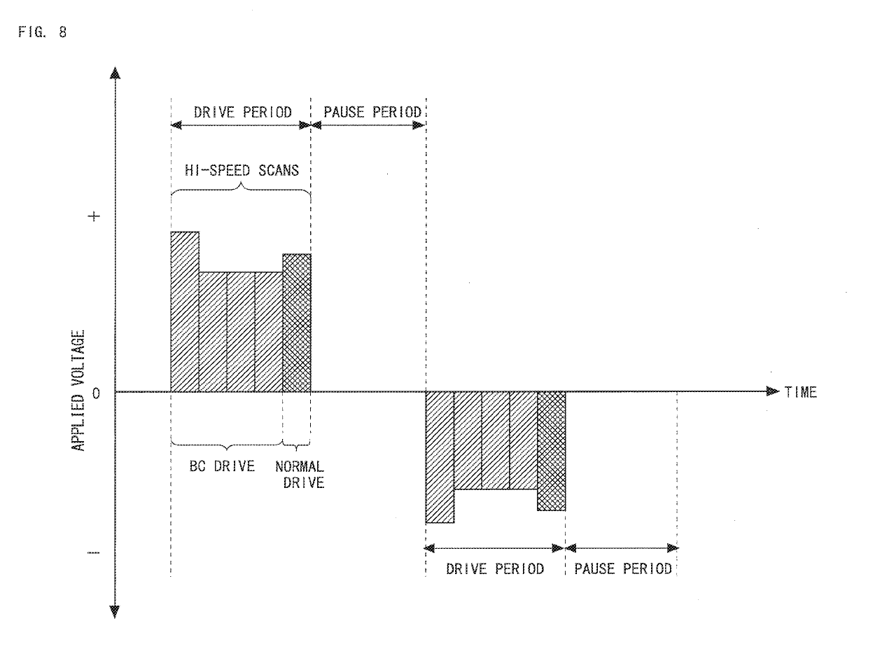

Therefore, during operating frames, high-speed scans are performed at a frame rate of 120 Hz (i.e., in cycles of 8.3 ms), along with BC drive. FIG. 7 is a diagram illustrating an example of a change in image luminance where high-speed scans and BC drive are performed. As shown in FIG. 7, initially during Operating Frame One of a drive period immediately following a pause period, image data DV is corrected by adding thereto a correction value read out from the first LUT 170a, and on the basis of the resultant corrected image data DVA, a corrected image voltage (also referred to as a “first boost-charge voltage” or a “first gradation value emphasizing voltage”) is generated, whereby BC drive and a high-speed scan are performed. Next, during Operating Frame Two, image data DV is corrected by subtracting therefrom a correction value read out from the second LUT 170b, and on the basis of the resultant corrected image data DVA, a corrected image voltage (also referred to as a “second boost-charge voltage” or a “second gradation value emphasizing voltage”) is generated, whereby BC drive and a high-speed scan are performed. During Operating Frame Three, a high-speed scan is performed alone without correction of image data DV. Accordingly, the operating frame number counter circuit 130 does not output an LUT selection signal SLS during Operating Frame Three. Thereafter, a pause frame follows Operating Frame Three, whereby a transition to a pause period occurs so as to perform pause drive in which a still image is displayed with an image signal used in Operating Frame Three being held.

In this case, during each operating frame, the luminance is lower than in the case shown in FIG. 6, but during Operating Frame Three, the luminance is slightly higher than the original level. Moreover, the luminance gradually decreases to the original level during the subsequent pause period. In this manner, the luminance change during Operating Frames One and Two is less than in the case shown in FIG. 6, and further, the luminance returns to the original level in a short period of time, with the result that flicker becomes much less likely to be perceived. Note that the times when the image luminance starts to change in FIGS. 6 and 7 are illustrative only and vary depending on influences of the response speed and the temperature of the liquid crystal.

In the embodiment, during Operating Frame Three of the drive period, only the high-speed scan is performed without correction of the image data DV. However, during Operating Frame Three also, BC drive, along with the high-speed scan, may be performed as a result of the image data DV being corrected by way of subtracting a correction value using the second LUT 170b.

<1.5 Effects>

In the present embodiment, regardless of whether the number of pause frames in an immediately preceding pause period is high, or whether there is an image change immediately after a transition from the pause period to a drive period, high-speed scans are performed from Operating Frame One through Operating Frame Three, and BC drive, in which a boost-charge voltage is written, is performed during Operating Frames One and Two. As a result, the change in image luminance immediately after the transition from the pause period to the drive period can be suppressed in a short period of time, and therefore, the occurrence of flicker as perceived by the viewer can be suppressed. Moreover, the high-speed scans are performed only from Operating Frame One through Operating Frame Three, and therefore, power consumption in the liquid crystal display device 1 can be reduced.

<1.6 First Variant>

The present embodiment has been described with respect to the case as shown in FIG. 7 where the image data DV is corrected using the second LUT 170b, such that the gradation value of the image data DV decreases, and BC drive and the high-speed scan are performed using the corrected image data DV only during Operating Frame Two. However, in the case where the number of operating frames in the drive period is greater than or equal to four, it may be so configured that the correction using the first LUT 170a is performed during one operating frame, no correction is performed during one operating frame, and during the remaining operating frames, BC drive and high-speed scans are performed using the corrected image data DVA obtained by means of the second LUT 170b.

FIG. 8 is a diagram illustrating an example of a change of a voltage applied to the liquid crystal layer of the pixel forming portion 20 by a drive method according to a first variant of the present embodiment. For example, in the case where the number of operating frames is determined to be “5”, as shown in FIG. 8, on the basis of a frame rate memorized in the register of the pause/operating frame distinguishing circuit 120, the operating frame number counter circuit 130 outputs an LUT selection signal SLS to select the first LUT 170a when an operating frame detection signal SRDT is provided during Operating Frame One. Moreover, in the case where the operating frame detection signal SRDT is provided during Operating Frame Five, neither LUT is selected, and therefore, the operating frame number counter circuit 130 outputs no LUT selection signal SLS. However, in the case where the operating frame detection signal SRDT is provided during Operating Frames Two through Four, the operating frame number counter circuit 130 outputs an LUT selection signal SLS for each operating frame so as to select the second LUT 170b. In this case, even if flicker is not sufficiently suppressed when the number of operating frames is three, flicker can be more reliably suppressed by increasing the number of operating frames to four or more. Note that the present variant can also be applied to each embodiment to be described later, thereby achieving a similar effect.

<1.7 Second Variant>

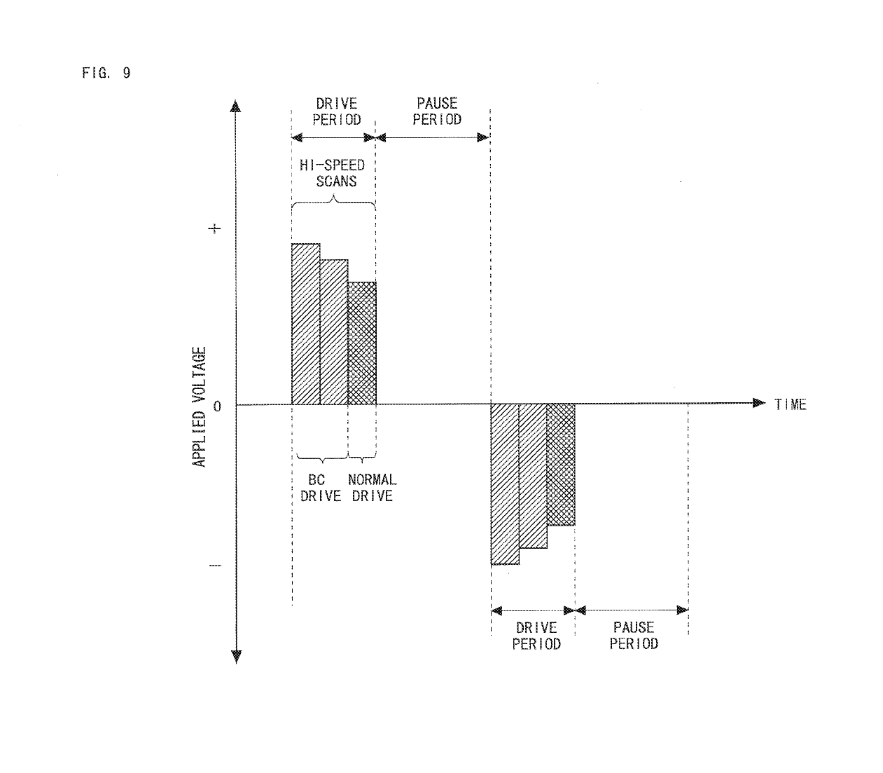

The present embodiment has been described with respect to the case as shown in FIG. 7 where the correction during Operating Frame One of the drive period is performed through addition of a correction value, and the correction during Operating Frame Two is performed through subtraction of a correction value. However, the correction during Operating Frame Two may be performed through addition of a correction value. FIG. 9 is a diagram illustrating an example of a change of a voltage applied to the liquid crystal layer of the pixel forming portion 20 by a drive method according to a second variant of the present embodiment. During Operating Frame Two of the drive period, as during Operating Frame One, the correction is performed through addition of a correction value, as shown in FIG. 9. The correction is performed using a correction value lower than that used for the correction during Operating Frame One. As a result, image luminance during Operating Frame Two can be rendered lower than that during Operating Frame One but higher than that during Operating Frame Three. Note that the correction may be performed through subtraction of a correction value during Operating Frame One of the drive period and also through addition of a correction value during Operating Frame Two, or the correction may be performed through subtraction of a correction value during both Operating Frames One and Two. Moreover, the present variant can also be applied to each embodiment to be described later, thereby achieving a similar effect.

### 2. Second Embodiment

The configuration of a liquid crystal display device according to a second embodiment of the present invention is the same as the configuration of the liquid crystal display device 1 according to the first embodiment shown in FIG. 1, and therefore, any block diagram and description thereof will be omitted. In the case of the liquid crystal display device according to the present embodiment, when the number of pause frames in a pause period is higher than a predetermined number, BC drive and the high-speed scan are performed during an immediately following drive period, but when the number of pause frames is lower than the predetermined number, neither BC drive nor the high-speed scan is performed.

<2.1 Configuration and Operation of the Correction Circuit>

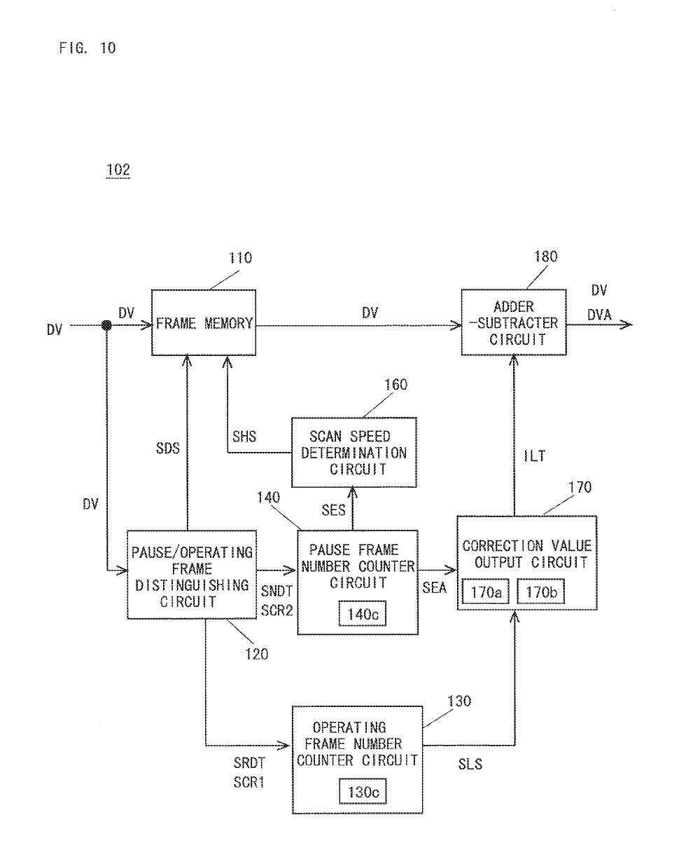

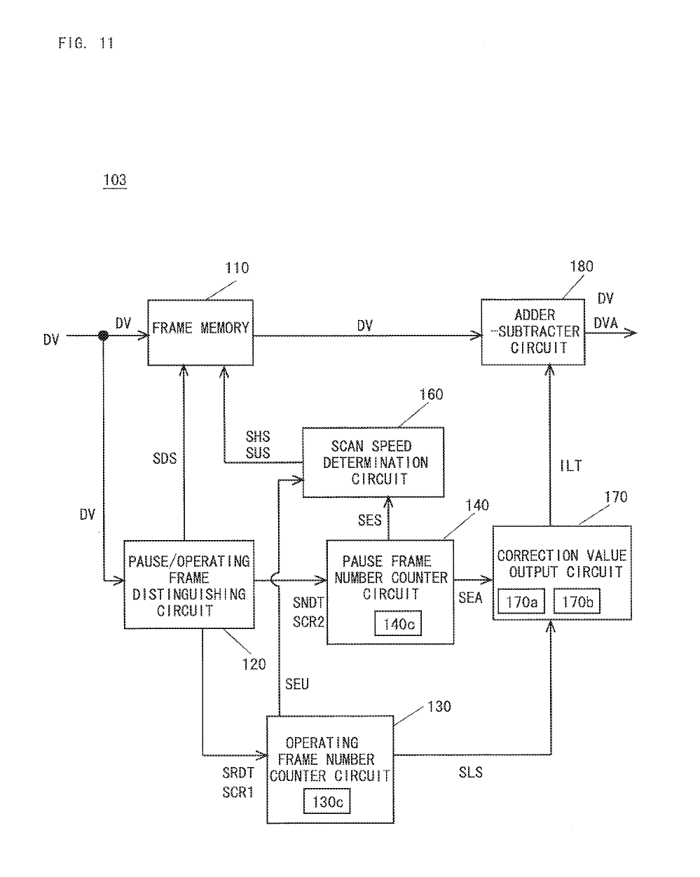

FIG. 10 is a block diagram illustrating the configuration of a correction circuit 102 included in a display control circuit of the liquid crystal display device according to the present embodiment. The correction circuit 102 shown in FIG. 10 is configured by additionally providing a pause frame number counter circuit 140 and a scan speed determination circuit 160 in the correction circuit 101 shown in FIG. 2. Therefore, the same components as those of the correction circuit 101 shown in FIG. 2 are denoted by the same reference characters, and any descriptions thereof will be omitted; the pause frame number counter circuit 140 and the scan speed determination circuit 160 will be described mainly.

The pause frame number counter circuit 140 includes a counter 140c (also referred to as a “second counter”), and increments a count value of the counter 140c by 1 upon each provision of a pause frame detection signal SNDT from the pause/operating frame distinguishing circuit 120. When the count value reaches a predetermined value, the pause frame number counter circuit 140 outputs a high-speed-scan enable signal SES to the scan speed determination circuit 160 and an LUT enable signal SEA (also referred to as a “table enable signal”) to the correction value output circuit 170.

Furthermore, the pause/operating frame distinguishing circuit 120 outputs a count reset signal SCR2 to the pause frame number counter circuit 140 upon detection of an operating frame on the basis of a frame rate of image data DV, which is memorized in the register. Upon provision of the count reset signal SCR2, the pause frame number counter circuit 140 resets the count value of the counter 140c counting the number of pause frames, to “0”. As a result, in transition from a drive period to another pause period, the number of pause frames in the pause period can be counted.

Upon provision of the high-speed-scan enable signal SES from the pause frame number counter circuit 140, the scan speed determination circuit 160 outputs a high-speed-scan signal SHS to the frame memory 110. When the frame memory 110 is provided with a data read start signal SDS from the pause/operating frame distinguishing circuit 120 and a high-speed-scan signal SHS from the pause frame number counter circuit 140, the frame memory 110 reads out image data DV being held therein, at a frame rate of 120 Hz and outputs the image data DV to the adder-subtracter circuit 180. For example, once the pause frame number counter circuit 140 outputs the high-speed-scan enable signal SES to the scan speed determination circuit 160 during Operating Frames One through Three, the scan speed determination circuit 160 outputs the high-speed-scan signal SHS to the frame memory 110. As a result, high-speed scans are performed during Operating Frames One through Three.

Upon provision of the LUT enable signal SEA from the pause frame number counter circuit 140, the correction value output circuit 170 selects either of the first and second LUTs 170a and 170b in accordance with an LUT selection signal SLS provided by the operating frame number counter circuit 130. For example, when a count value of the counter 130c in the operating frame number counter circuit 130 is “1”, which denotes Operating Frame One, the correction value output circuit 170 is provided with an LUT selection signal SLS to select the first LUT 170a. When the count value is “2”, which denotes Operating Frame Two, the correction value output circuit 170 is provided with an LUT selection signal SLS to select the second LUT 170b. As a result, the adder-subtracter circuit 180 corrects the image data DV to obtain corrected image data DVA, whereby BC drive can be performed during Operating Frames One and Two. However, during Operating Frame Three, the adder-subtracter circuit 180 outputs the image data DV without correction, and therefore, BC drive is not performed. At this time, the operating frame number counter circuit 130 does not output the LUT selection signal SLS to the correction value output circuit 170.

In this manner, when the count value for the number of pause frames in the immediately preceding pause period reaches a given predetermined value, the high-speed scans are performed along with BC drive during Operating Frames One and Two, and along with normal drive during Operating Frame Three.

<2.2 Effects>

In transition from the pause period to the drive period, the change in image luminance increases with the duration of the pause period, i.e., the number of pause frames. Therefore, in the present embodiment, when the number of pause frames in the pause period is higher than a predetermined value, BC drive and the high-speed scan are performed during each operating frame of the drive period immediately following the pause period, as in the first embodiment. Thus, the change in image luminance immediately after the transition from the pause period to the drive period can be suppressed in a short period of time, whereby the occurrence of flicker as perceived by the viewer can be suppressed.

<2.3 Variant>

FIG. 11 is a block diagram illustrating the configuration of a correction circuit 103 included in a display control circuit of a liquid crystal display device according to a variant of the present embodiment. The operating frame number counter circuit 130 included in the correction circuit 103 shown in FIG. 11 operates in the same manner as in the embodiment, and further, increments the count value of the counter 130c by “1” during Operating Frame Four and thereafter as well upon each provision of an operating frame detection signal SRDT from the pause/operating frame distinguishing circuit 120. However, once the count value of the counter 130c exceeds the number of frames during which the high-speed scan is to be performed (in the present embodiment, “3”), the operating frame number counter circuit 130 outputs a normal-scan enable signal SEU to the scan speed determination circuit 160, thereby stopping the LUT selection signal SLS from being outputted.

Accordingly, when a high-speed-scan enable signal SES is provided by the pause frame number counter circuit 140, the scan speed determination circuit 160 outputs a high-speed-scan signal SHS to the frame memory 110. Moreover, when a normal-scan enable signal SEU is provided by the operating frame number counter circuit 130, the scan speed determination circuit 160 outputs a normal-scan signal SUS to the frame memory 110.

As a result, during Operating Frames One and Two immediately after the transition from the pause period to the drive period, high-speed scans are performed at a frame rate of 120 Hz, along with BC drive, and during Operating Frame Three, a high-speed scan and normal drive are performed. Further, from Operating Frame Four to a predetermined frame, normal scans are performed at a frame rate of 60 Hz, along with normal drive, and thereafter, a transition to another pause period occurs.

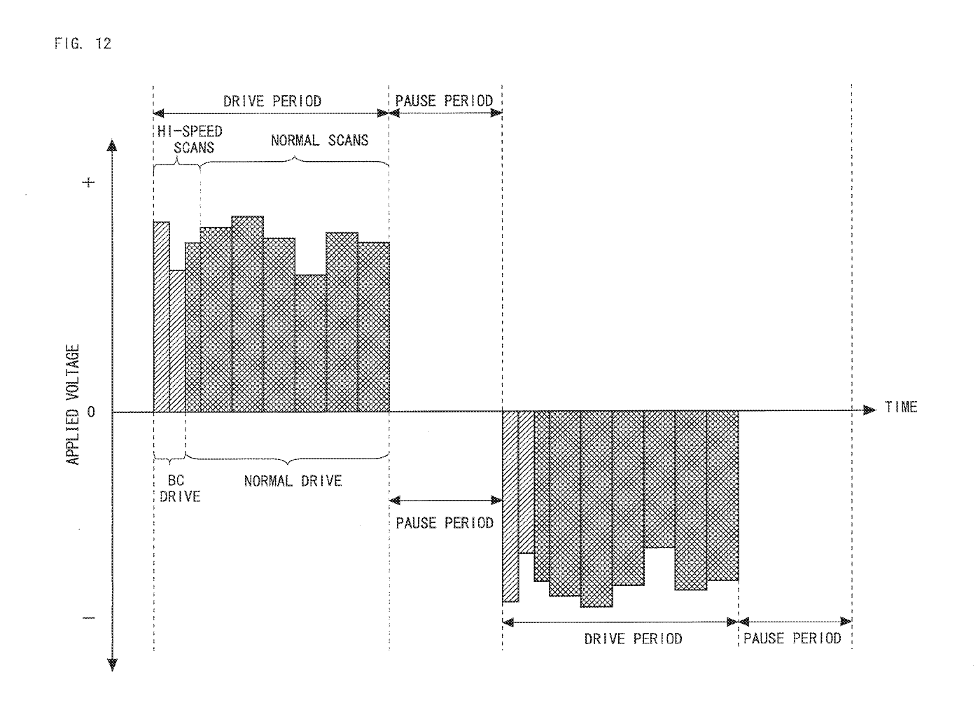

FIG. 12 is a diagram illustrating an example of a change of a voltage applied to the liquid crystal layer of the pixel forming portion 20 by a drive method of the present variant. As shown in FIG. 12, during Operating Frame One and Two immediately after the transition from the pause period to the drive period, the liquid crystal display device performs high-speed scans at a frame rate of 120 Hz, along with BC drive, as described in the present embodiment. During Operating Frame Three, a high-speed scan and normal drive are performed. Further, from Operating Frame Four to Operating Frame Nine, an image continues to be displayed by performing normal scans at a frame rate of 60 Hz without correction of image data DV, and thereafter, a transition to another pause period occurs. In this manner, during Operating Frame Four and thereafter, normal scans and normal drive are performed, whereby power consumption in the liquid crystal display device can be suppressed. Note that the present variant can also be applied to each embodiment to be described later, thereby achieving a similar effect.

### 3. Third Embodiment

The configuration of a liquid crystal display device according to a third embodiment of the present invention is the same as the configuration of the liquid crystal display device according to the first embodiment shown in FIG. 1, and therefore, any block diagram and description thereof will be omitted. In the case of the liquid crystal display device according to the present embodiment, when there is no image change upon transition from the pause period to the drive period, flicker is more likely to be perceived, and therefore, BC drive and high-speed scans are performed immediately after the transition to the drive period. On the other hand, when there is an image change, flicker is less likely to be perceived, and therefore, neither BC drive nor a high-speed scan is performed.

<3.1 Configuration and Operation of the Correction Circuit>

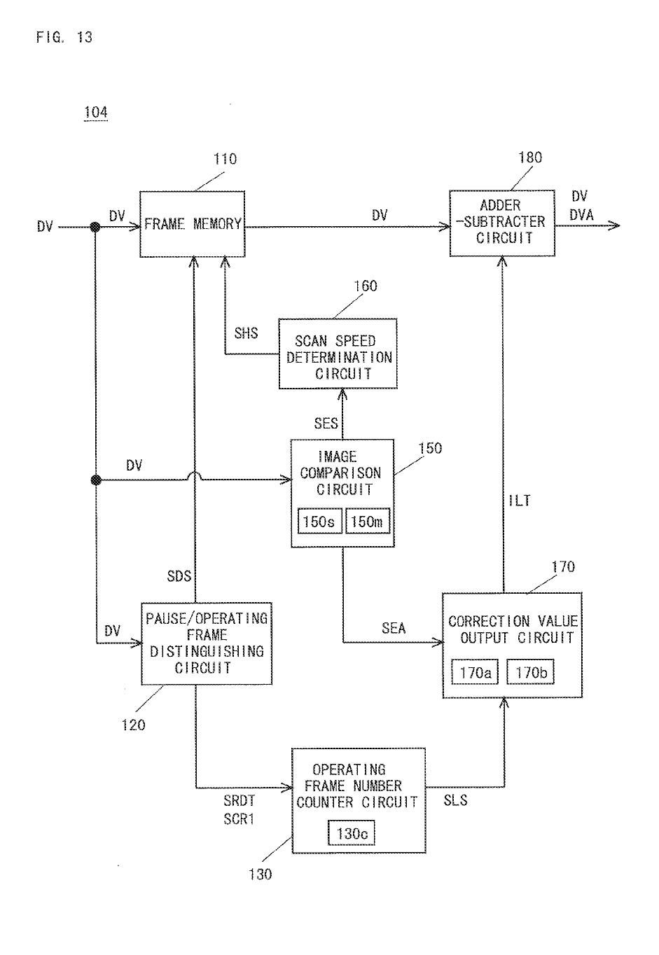

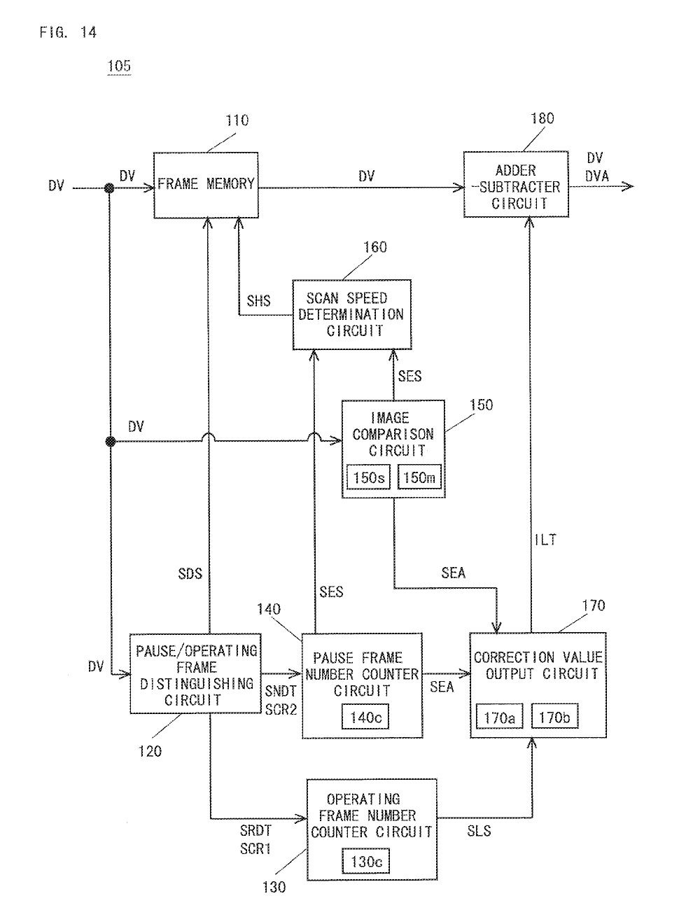

FIG. 13 is a block diagram illustrating the configuration of a correction circuit 104 included in a display control circuit of the liquid crystal display device according to the present embodiment. The correction circuit 104 shown in FIG. 13 is configured by providing an image comparison circuit 150 in the correction circuit 102 shown in FIG. 10, in place of the pause frame number counter circuit 140. Therefore, the same components as those of the correction circuit 102 shown in FIG. 10 are denoted by the same reference characters, and any descriptions thereof will be omitted; the image comparison circuit 150 will be described mainly.

The image comparison circuit 150 includes a checksum circuit 150s, which obtains a checksum value for each operating frame, and memory 150m, which memorizes a checksum value calculated by the checksum circuit 150s for an immediately preceding operating frame. The image comparison circuit 150 determines whether there is a change in an image for Operating Frame One immediately after a transition from a pause period to a drive period, compared to an image displayed during the pause period immediately preceding the transition. For the determination, the image comparison circuit 150 obtains a checksum value for the image through the checksum circuit 150s on the basis of image data DV provided by an external signal source 90, and compares the checksum value with a checksum value memorized in the memory 150m for the image displayed during the pause period. If the determination result is that both values are the same, the image comparison circuit 150 deems that there is no change in the image to be displayed during Operating Frame One, compared to the image displayed during the immediately preceding pause period, and outputs a high-speed-scan enable signal SES to the scan speed determination circuit 160 and an LUT enable signal SEA to the correction value output circuit 170. On the other hand, if the determination result is that both values are different, the image comparison circuit 150 deems that there is a change in the image to be displayed during Operating Frame One, compared to the image displayed during the immediately preceding pause period, with the result that neither the high-speed-scan enable signal SES nor the LUT enable signal SEA is outputted.

It should be noted that during the drive period also, upon each provision of new image data, a checksum value for that image is obtained so as to replace the checksum value memorized in the memory 150m. The obtained checksum value is not used during the drive period. However, in transition from the drive period to the pause period, a checksum value for an image displayed during the last operating frame is held in the memory 150m until the end of the pause period, and then used for image comparison upon the next transition to another drive period.

In the present embodiment, the frame memory 110 provided with the high-speed-scan signal SHS and the data read start signal SDS, the correction value output circuit 170 provided with the LUT enable signal SEA and the LUT selection signal SLS, and the adder-subtracter circuit 180 operate in the same manner as in the second embodiment shown in FIG. 10, and therefore, any descriptions thereof will be omitted.

As described above, when the image for Operating Frame One is the same as the image for the pause frame in the immediately preceding pause period, the scan speed determination circuit 160 outputs the high-speed-scan signal SHS, thereby performing a high-speed scan on the liquid crystal display panel 10. Moreover, the correction value output circuit 170 is activated, whereby a correction value is outputted to the adder-subtracter circuit 180 from either the first or second LUT 170a or 170b selected by the LUT selection signal SLS provided by the operating frame number counter circuit 130. The adder-subtracter circuit 180 corrects image data using the provided correction value, thereby generating corrected image data DVA, and outputs the generated data to the source driver 40. As a result, BC drive and high-speed scans are performed during Operating Frames One and Two, and a high-speed scan and normal drive are performed during Operating Frame Three.

<3.2 Effects>

In the case where there is no image change upon transition from the pause period to the drive period, image luminance changes noticeably during the drive period immediately after the transition, but the change in image luminance is not significantly perceptible if there is an image change. Accordingly, in the present embodiment, the checksum values obtained by the checksum circuit 150s provided in the image comparison circuit 150 are compared in order to determine whether the image displayed immediately after the transition from the pause period to the drive period is the same as the image displayed during the pause period immediately preceding the transition. If the determination result is that the images are the same, BC drive and a high-speed scan are performed during each operating frame, as in the first embodiment, whereby any change in image luminance, which is perceptible upon transition from the pause period to the drive period, can be suppressed in a short period of time. Thus, the occurrence of flicker as perceived by the viewer can be suppressed. Moreover, in the case where there is an image change, normal drive and a normal scan are performed during each operating frame. Thus, power consumption in the liquid crystal display device can be reduced.

<3.3 Variant>

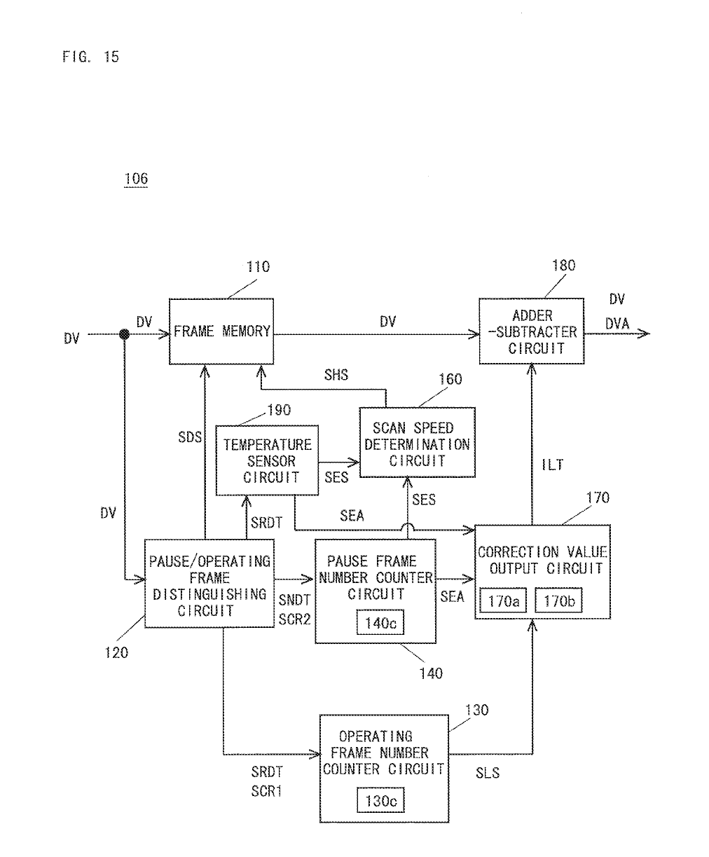

FIG. 14 is a block diagram illustrating the configuration of a correction circuit 105 included in a display control circuit of a liquid crystal display device according to a variant of the present embodiment. As shown in FIG. 14, the correction circuit 105 in the present variant is configured by additionally providing the pause frame number counter circuit 140 shown in FIG. 10 to the correction circuit 104 in the present embodiment shown in FIG. 13. Accordingly, of the components of the correction circuit 104 shown in FIG. 14, only some essential components will be described briefly.

When image data DV is provided by the external signal source 90, the image comparison circuit 150 obtains a checksum value for the image data DV and also for image data DV for an immediately preceding pause frame, and determines whether the values are equal, as described in the present embodiment. When the result is that the values are equal, a high-speed-scan enable signal SES is outputted to the scan speed determination circuit 160, and an LUT enable signal SEA is outputted to the correction value output circuit 170. Further, when the number of pause frames in the pause period, counted by the counter 140c, reaches a predetermined value, the pause frame number counter circuit 140 outputs a high-speed-scan enable signal SES to the scan speed determination circuit 160 and an LUT enable signal SEA to the correction value output circuit 170, as described in the second embodiment.

The scan speed determination circuit 160 includes a register (not shown) for memorizing the number of frames in which a high-speed scan is to be performed. Accordingly, upon provision of a high-speed-scan enable signal SES from each of the pause frame number counter circuit 140 and the image comparison circuit 150, the scan speed determination circuit 160 outputs to the frame memory 110 as many high-speed-scan signals SHS as the number of frames memorized in the register. On the basis of a data read start signal SDS provided by the pause/operating frame distinguishing circuit 120 and the high-speed-scan signal SHS provided by the scan speed determination circuit 160, the frame memory 110 outputs image data DV to the adder-subtracter circuit 180 at a frame rate of 120 Hz.

When the LUT enable signal SEA is provided by each of the pause frame number counter circuit 140 and the image comparison circuit 150, and further, an LUT selection signal SLS by the operating frame number counter circuit 130, the correction value output circuit 170 outputs correction value information ILT, including a correction value from either the first or second LUT 170a or 170b selected by the LUT selection signal SLS, to the adder-subtracter circuit 180. The adder-subtracter circuit 180 adds or subtracts the correction value included in the correction value information ILT to or from the image data DV provided at a frame rate of 120 Hz, thereby generating corrected image data DVA, which is outputted to the source driver 40. Alternatively, when no correction value information ILT is provided to the adder-subtracter circuit 180, the image data DV is outputted to the source driver 40 without correction.

In this manner, when there is no change in the image to be displayed during Operating Frame One of the drive period, compared to the image displayed during the pause period, and the number of pause frames in the pause period is greater than or equal to a predetermined value, high-speed scans and BC drive are performed during Operating Frames One and Two, and a high-speed scan and normal drive are performed during Operating Frame Three. Thus, the change in image luminance, which is perceptible upon transition from the pause period to the drive period, can be suppressed in a short period of time. Note that when the pause period is short, or when there is an image change, flicker is not likely to be perceived, and therefore, a normal scan and normal drive are performed. Thus, power consumption in the liquid crystal display device can be inhibited from increasing.

### 4. Fourth Embodiment

The configuration of a liquid crystal display device according to a fourth embodiment of the present invention is the same as the configuration of the liquid crystal display device 1 according to the first embodiment shown in FIG. 1, and therefore, any block diagram and description thereof will be omitted. The response speed of the liquid crystal is faster at high temperature than at normal temperature, and therefore, flicker is more likely to be perceived at high temperature. In contrast, the response speed slows as the temperature approximates normal temperature, with the result that flicker becomes less likely to be perceived. Accordingly, in high-temperature range where flicker is more likely to be perceived, a high-speed scan is performed so as to suppress flicker. Further, flicker can be rendered less perceivable as in the other embodiments by performing BC drive when the temperature is high or by performing normal drive when the temperature is low.

<4.1 Configuration and Operation of the Correction Circuit>

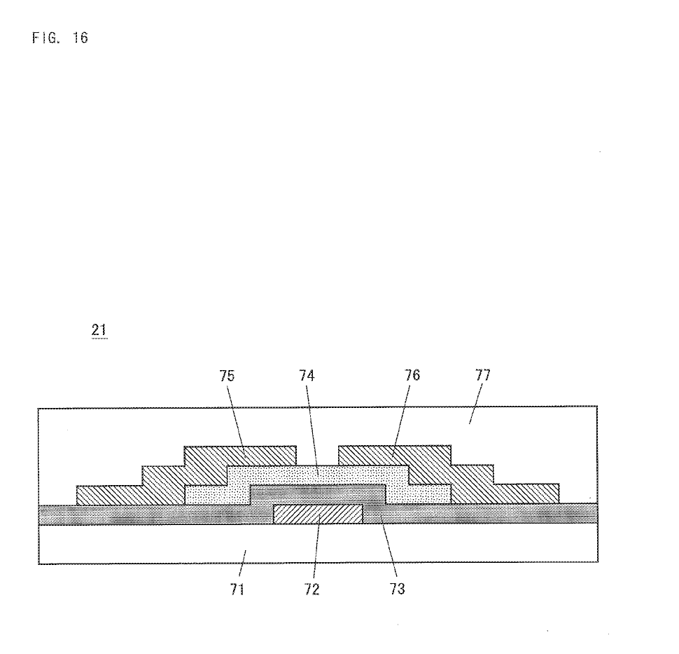

FIG. 15 is a block diagram illustrating the configuration of a correction circuit 106 included in a display control circuit of the liquid crystal display device according to the present embodiment. The correction circuit 106 shown in FIG. 15 is configured by additionally providing a temperature sensor circuit 190 in the correction circuit 102 shown in FIG. 10. The temperature sensor circuit 190 is disposed on the liquid crystal display panel 10 in order to measure the temperature of the liquid crystal display panel 10. The temperature of the liquid crystal display panel 10 is approximately equal to the temperature of the liquid crystal layer in the pixel forming portion 20, and therefore, the measured temperature is considered to be the temperature of the liquid crystal layer.

The temperature sensor circuit 190 measures the temperature upon provision of an operating frame detection signal SRDT from the pause/operating frame distinguishing circuit 120, and when the measured temperature is higher than a predetermined value, outputs a high-speed-scan enable signal SES to the scan speed determination circuit 160. Moreover, when the count value for the number of pause frames reaches a predetermined value, the pause frame number counter circuit 140 outputs a high-speed-scan enable signal SES to the scan speed determination circuit 160, as described in the second embodiment. Upon provision of the high-speed-scan enable signals SES from the temperature sensor circuit 190 and the pause frame number counter circuit 140, the scan speed determination circuit 160 outputs a high-speed-scan signal SHS to the frame memory 110 in order to perform a high-speed scan on the liquid crystal display panel 10. The frame memory 110 provided with the high-speed-scan signals SHS reads out image data DV at a scan speed determined by a temperature information signal, whereby the high-speed scan can be performed, as described in the second embodiment.

In this case, the temperature sensor circuit 190 and the pause frame number counter circuit 140 output LUT enable signals SEA to the correction value output circuit 170. Upon provision of an LUT selection signal SLS from the operating frame number counter circuit 130, in addition to the LUT enable signals SEA provided by the temperature sensor circuit 190 and the pause frame number counter circuit 140, the correction value output circuit 170 selects either of the first and second LUTs 170a and 170b on the basis of the LUT selection signal SLS, and outputs correction value information ILT, including a correction value, to the adder-subtracter circuit 180. Thus, the adder-subtracter circuit 180 corrects image data DV on the basis of the correction value information ILT, thereby obtaining corrected image data DVA, with the result that BC drive can be performed, as described in the second embodiment.

In this manner, in transition from the pause period to the drive period, when the temperature measured by the temperature sensor circuit 190 is higher than the predetermined value, a high-speed scan is performed, along with BC drive, which is performed as a result of the LUT enable signals SEA being provided to the correction value output circuit 170. On the other hand, when the temperature of the liquid crystal layer is lower than the predetermined value, flicker is less likely to be perceived, and therefore, a normal scan and normal drive are performed without the LUT enable signals SEA being provided to the correction value output circuit 170.

The temperature sensor circuit 190 has been described above as determining whether to perform a high-speed scan depending on whether the predetermined value is exceeded. However, the temperature sensor circuit 190 may provide the measured temperature to the scan speed determination circuit 160 as temperature information, such that the scan speed determination circuit 160 determines the scan speed on the basis of the temperature information. In this case, the scan speed can be set more finely in accordance with the temperature of the liquid crystal layer, and therefore, flicker can be rendered much less likely to be perceived.

Furthermore, the foregoing description is directed to the correction circuit 106, which is configured by adding the temperature sensor circuit 190 to the correction circuit 102 shown in FIG. 10. However, the correction circuit to which the temperature sensor circuit 190 can be added is not limited to this, and such an addition can also be made to the correction circuit 103 shown in FIG. 11, the correction circuit 104 shown in FIG. 13, and the correction circuit 105 shown in FIG. 14; in any of the cases, effects similar to those achieved by the present embodiment can be achieved.

<4.2 Effects>

The present embodiment takes advantage of the response speed of the liquid crystal depending on the temperature, such that when the temperature of the liquid crystal upon transition from the pause period to the normal period is higher than the predetermined value, the high-speed scan is performed, along with BC drive, whereby the change in image luminance is suppressed, with the result that flicker becomes less likely to be perceived. Moreover, when the temperature of the liquid crystal is lower than the predetermined value, the normal scan is performed, whereby power consumption in the liquid crystal display device can be reduced.

### 5. TFT in the Pixel Forming Portion

The TFT 21, which is included in the pixel forming portion 20 of the liquid crystal display device according to each embodiment of the present invention and serves as a switching element, will now be described. The TFT 21 included in the pixel forming portion 20, as shown in FIG. 1, may be a channel-etched or an etch-stop TFT with an oxide semiconductor layer. The oxide semiconductor layer may be formed with an indium gallium zinc oxide or a crystalline oxide semiconductor, or may have a stack structure. By using the TFT with an oxide semiconductor layer, it becomes possible to significantly cut down the number of times of driving the liquid crystal panel while maintaining display quality, and also significantly diminish power consumption by the liquid crystal display device.

FIG. 16 is a diagram illustrating the structure of a channel-etched TFT. As shown in FIG. 16, the channel-etched TFT is structured such that a gate electrode 72, a gate insulating film 73, an oxide semiconductor layer 74, a source electrode 75, and a drain electrode 76 are stacked on a substrate 71, and a protective film 77 is formed on top. A portion of the oxide semiconductor layer 74 that lies above the gate electrode 72 functions as a channel region. The channel-etched TFT has no etch-stop layer formed on the channel region, and the source electrode 75 and the drain electrode 76 are disposed such that bottom surfaces of channel-side ends contact a top surface of the oxide semiconductor layer 74. The channel-etched TFT is completed, for example, by forming a conductive film serving as a source/drain electrode on the oxide semiconductor layer 74 and performing the process of separating the source and the drain. In some cases, the surface of the channel region is etched during the source-drain separating process.

The etch-stop TFT (not shown) has an etch-stop layer formed on a channel region. Source and drain electrodes are such that bottom surfaces of channel-side ends are positioned, for example, on the etch-stop layer. The etch-stop TFT is completed, for example, by forming the etch-stop layer so as to cover a portion of an oxide semiconductor layer that serves as the channel region, thereafter forming a conductive film that serves as a source/drain electrode on the oxide semiconductor layer and the etch-stop layer, and performing the process of separating the source and the drain.

The oxide semiconductor included in the oxide semiconductor layer of the TFT may be an amorphous oxide semiconductor or a crystalline oxide semiconductor with a crystalline portion. As the crystalline oxide semiconductor, for example, a polycrystalline oxide semiconductor, a microcrystalline oxide semiconductor, or a crystalline oxide semiconductor with the c-axis oriented approximately vertical to the surface of the layer can be used.

The oxide semiconductor layer of the TFT may have a stack structure of two or more layers. In such a case, the oxide semiconductor layer may include both a non-crystalline oxide semiconductor layer and a crystalline oxide semiconductor layer, a plurality of crystalline oxide semiconductor layers with different crystal structures, or a plurality of non-crystalline oxide semiconductor layers. In the case where the oxide semiconductor layer has a two-layer structure including top and bottom layers, the oxide semiconductor contained in the top layer preferably has a larger energy gap than the oxide semiconductor contained in the bottom layer. However, in the case where the difference in energy gap between the two layers is relatively small, the bottom-layer oxide semiconductor may have a larger energy gap than the top-layer oxide semiconductor.

The materials, the structures, and the forming methods of the non-crystalline oxide semiconductor and the crystalline oxide semiconductors, along with the configurations of the oxide semiconductor layers with stack structures, etc., are described in, for example, Japanese Laid-Open Patent Publication No. 2014-7399. The disclosure of Japanese Laid-Open Patent Publication No. 2014-7399 is incorporated herein by reference in its entirety.

The oxide semiconductor layer may contain, for example, at least one of the following metallic elements: In, Ga, and Zn. The oxide semiconductor layer includes, for example, an In—Ga—Zn—O based semiconductor (e.g., indium gallium zinc oxide). The In—Ga—Zn—O based semiconductor is a ternary oxide composed of In (indium), Ga (gallium), and Zn (zinc). The ratio (composition ratio) of In, Ga, and Zn is not specifically limited, and may be such that, for example, In:Ga:Zn=2:2:1, In:Ga:Zn=1:1:1, or In:Ga:Zn=1:1:2. The oxide semiconductor layer is formed using an oxide semiconductor film containing an In—Ga—Zn—O based semiconductor.

The In—Ga—Zn—O based semiconductor may be amorphous or crystalline. The crystalline In—Ga—Zn—O based semiconductor preferably has the c-axis oriented approximately vertical to the layer surface.

It should be noted that the crystal structure of the crystalline In—Ga—Zn—O based semiconductor is disclosed, for example, in Japanese Laid-Open Patent Publication No. 2014-7399, mentioned earlier, as well as in Japanese Laid-Open Patent Publication Nos. 2012-134475 and 2014-209727. The disclosures of Japanese Laid-Open Patent Publication Nos. 2012-134475 and 2014-209727 are incorporated herein by reference in their entirety. TFTs with In—Ga—Zn—O based semiconductor layers offer high mobility (more than 20 times as high as a-Si TFTs) and low leakage current (less than 1/100 of that of a-Si TFTs). Accordingly, TFTs with In—Ga—Zn—O based semiconductor layers are preferably used as drive TFTs (e.g., the TFTs being included in driver circuits provided around a display area, which includes a plurality of pixel circuits, on the same substrate), and also as pixel TFTs (the TFTs being provided in pixel circuits).

Instead of containing the In—Ga—Zn—O based semiconductor, the oxide semiconductor layer may contain another oxide semiconductor. The oxide semiconductor layer may contain, for example, an In—Sn—Zn—O based semiconductor (e.g., In₂O₃—SnO₂—ZnO or InSnZnO). The In—Sn—Zn—O based semiconductor is a ternary oxide composed of In (indium), Sn (tin), and Zn (zinc). Moreover, the oxide semiconductor layer may contain an In—Al—Zn—O based semiconductor, an In—Al—Sn—Zn—O based semiconductor, a Zn—O based semiconductor, an In—Zn—O based semiconductor, a Zn—Ti—O based semiconductor, a Cd—Ge—O based semiconductor, a Cd—Pb—O based semiconductor, CdO (cadmium oxide), an Mg—Zn—O based semiconductor, an In—Ga—Sn—O based semiconductor, an In—Ga—O based semiconductor, a Zr—In—Zn—O based semiconductor, an Hf—In—Zn—O based semiconductor, or the like. Here, Al, Ti, Cd, Ge, Pb, Mg, Zr, and Hf represent aluminum, titanium, cadmium, germanium, lead, magnesium, zirconium, and hafnium, respectively.

The foregoing has been described with respect to the case where the TFT 21 included in the pixel forming portion 20 is a TFT with a channel layer which is or includes an oxide semiconductor layer. However, peripheral circuits such as source and gate drivers may also be configured by TFTs with channel layers which are or include oxide semiconductor layers.

It should be noted that the frame memory 110, the pause frame number counter circuit, the image comparison circuit 150, and the scan speed determination circuit 160 will also be referred to herein collectively as the “high-speed scanning portion”, and the operating frame number counter circuit 130, the correction value output circuit 170, and the adder-subtracter circuit 180 as the “BC drive portion” or the “gradation value emphasizing drive portion”.

This application claims priority to Japanese Patent Application No. 2016-13971, filed Jan. 28, 2016 and titled “Display Device”, the disclosure of which is incorporated herein by reference.

### DESCRIPTION OF THE REFERENCE CHARACTERS

10 liquid crystal display panel
20 pixel forming portion
21 thin-film transistor (TFT)
26 pixel electrode
27 common electrode
28 liquid crystal capacitor (pixel capacitor)
30 gate driver
40 source driver
50 display control circuit
101 to 106 correction circuit
110 frame memory
120 pause/operating frame distinguishing circuit
130 operating frame number counter circuit
130c counter
140 pause frame number counter circuit
140c counter
150 image comparison circuit
150s checksum circuit
150m memory
160 scan speed determination circuit
170 correction value output circuit
170a first LUT
170b second LUT
180 adder-subtracter circuit
190 temperature sensor circuit

1. A display device capable of pause drive, comprising:
a display panel having formed thereon a plurality of scanning signal lines, a plurality of data signal lines, each crossing the scanning signal lines, and a plurality of pixel forming portions arranged in a matrix corresponding to intersections of the scanning signal lines and the data signal lines;
a signal line driver circuit configured to sequentially select the scanning signal lines and write an image signal voltage to the data signal lines, the image signal voltage being generated on the basis of externally inputted image data; and
a display control circuit configured to control an operation of the signal line driver circuit and including a correction circuit configured to correct the image data, wherein,
the correction circuit includes:
a pause/operating frame distinguishing circuit configured to output either an operating frame detection signal upon detection of an operating frame or a pause frame detection signal upon detection of a pause frame;
a high-speed scanning portion that controls a scan speed so that it can be written at a second speed higher than a first speed at which the image signal voltage obtained on the basis of the image data is written to the pixel forming portion; and
a gradation value emphasizing drive portion configured to obtain corrected image data by correcting the image data using either a first correction value or a second correction value and thereby render gradation value emphasizing drive possible,
the correction circuit generates first corrected image data during a first operating frame immediately after a transition from a pause period during which the pause drive is performed and a drive period during which normal drive is performed, the first corrected image data being obtained through a correction using the first correction value by activating the high-speed scanning portion and the gradation value emphasizing drive portion,
the correction circuit generates second corrected image data during a second operating frame consisting of one or more frames following the first operating frame, the second corrected image data being obtained through a correction using the second correction value by activating the gradation value emphasizing drive portion and the high-speed scanning portion, and
the signal line driver circuit writes a first gradation value emphasizing voltage generated on the basis of the first corrected image data to the pixel forming portion during the first operating frame and a second gradation value emphasizing voltage generated on the basis of the second corrected image data to the pixel forming portion during the second operating frame.

2. The display device according to claim 1, wherein the image signal voltage based on the image data is written to the pixel forming portion at the second speed during a third operating frame following the second operating frame, by activating only the high-speed scanning portion.

3. The display device according to claim 1, wherein,
the gradation value emphasizing drive portion includes an adder-subtracter circuit configured to correct the image data using the first correction value or the second correction value, and
the adder-subtracter circuit obtains the first corrected image data by adding or subtracting the first correction value to or from the image data or obtains the second corrected image data by adding or subtracting the second correction value to or from the image data.

4. The display device according to claim 1, wherein,
the second correction value is lower than the first correction value,
the gradation value emphasizing drive portion includes an adder-subtracter circuit configured to correct the image data using the first correction value or the second correction value, and
the adder-subtracter circuit obtains the first corrected image data by adding the first correction value to the image data and obtains the second corrected image data by adding the second correction value to the image data.

5. The display device according to claim 3, wherein,
the high-speed scanning portion includes frame memory configured to hold the externally inputted image data,
the gradation value emphasizing drive portion further includes:
an operating frame number counter circuit having a first counter configured to count the number of operating frames upon each provision of an operating frame detection signal from the pause/operating frame distinguishing circuit, the operating frame number counter circuit being configured to output a table selection signal in accordance with a count value of the first counter; and
a correction value output circuit having a first table and a second table and configured to select either the first table or the second table in accordance with the count value provided by the operating frame number counter circuit and provide an output to the adder-subtracter circuit, and
the operating frame number counter circuit outputs the table selection signal to select the first table when the count value of the first counter is “1” and does not output the table selection signal when the count value of the first counter is greater than or equal to 3 but outputs the table selection signal to select the second table when the count value is greater than “1”, but less than, equal to, or greater than 3.

6. The display device according to claim 5, wherein the count value of the first counter is reset by a pause frame detection signal outputted by the pause/operating frame distinguishing circuit.

7. The display device according to claim 5, wherein,
the high-speed scanning portion further includes:
a pause frame number counter circuit having a second counter configured to count the number of operating frames upon each provision of a pause frame detection signal from the pause/operating frame distinguishing circuit; and
a scan speed determination circuit configured to cause the frame memory to output the image data at the second speed,
the pause frame number counter circuit outputs a high-speed-scan enable signal to the scan speed determination circuit and a table enable signal to the correction value output circuit when a count value of the second counter reaches a predetermined value, the high-speed-scan enable signal rendering possible the outputting of the image data from the frame memory at the second speed, the table enable signal rendering possible the selecting of the first table or the second table,
the scan speed determination circuit outputs a high-speed-scan signal to the frame memory so as to cause the frame memory to output the image data to the adder-subtracter circuit at the second speed, and
upon provision of the table selection signal from the operating frame number counter circuit, the correction value output circuit is allowed to select either the first table or the second table in accordance with the table selection signal.

8. The display device according to claim 7, wherein the count value of the second counter is reset by an operating frame detection signal outputted by the pause/operating frame distinguishing circuit.

9. The display device according to claim 5, wherein,
the high-speed scanning portion further includes:
an image comparison circuit configured to determine by a checksum value whether an image represented by the externally inputted image data is the same as an image represented by image data externally inputted immediately before the externally inputted image data; and
a scan speed determination circuit configured to cause the frame memory to output the image data at the second speed,
the image comparison circuit has a checksum circuit configured to obtain the checksum value and outputs a high-speed-scan enable signal to the scan speed determination circuit and a table enable signal to the correction value output circuit when a checksum value of externally inputted image data equals a checksum value of image data for an image displayed immediately before the externally inputted image data is provided,
the scan speed determination circuit outputs a high-speed-scan signal to the frame memory so as to allow the frame memory to output the image data to the adder-subtracter circuit at the second speed, and
upon provision of the table selection signal from the operating frame number counter circuit, the correction value output circuit is allowed to select either the first table or the second table.

10. The display device according to claim 7, wherein,
the high-speed scanning portion further includes an image comparison circuit configured to determine by a checksum value whether an image represented by the externally inputted image data is the same as an image represented by image data externally inputted immediately before the externally inputted image data is provided,
the image comparison circuit has a checksum circuit configured to obtain the checksum value and outputs a high-speed-scan enable signal to the scan speed determination circuit and a table enable signal to the correction value output circuit when a checksum value of externally inputted image data equals a checksum value of image data for an image displayed immediately before the externally inputted image data is provided,
upon provision of the high-speed-scan enable signal from each of the pause frame number counter circuit and the image comparison circuit, the scan speed determination circuit outputs a high-speed-scan signal to the frame memory so as to allow the frame memory to output the image data to the adder-subtracter circuit at the second speed, and
upon provision of the high-speed-scan enable signal from each of the pause frame number counter circuit and the image comparison circuit, the correction value output circuit is allowed to select the first table or the second table in accordance with the table selection signal.

11. The display device according to claim 1, wherein,
the high-speed scanning portion further includes:
frame memory configured to hold the externally inputted image data;
a temperature sensor circuit configured to measure a temperature of the display panel;
a scan speed determination circuit configured to scan the operating frame at a speed higher than the first speed in accordance with the temperature measured by the temperature sensor circuit; and
an adder-subtracter circuit configured to add or subtract a correction value to or from the image data,
the gradation value emphasizing drive portion further includes a correction value output circuit configured to select a table from among a plurality of tables containing correction values for the image data and provide an output to the adder-subtracter circuit, and
the temperature sensor circuit outputs temperature information to the scan speed determination circuit and a table enable signal to the correction value output circuit, the temperature information indicating the temperature of the display panel, the table enable signal renders the selecting of the table possible.

12. The display device according to claim 1, wherein,
the pixel forming portion includes:
a liquid crystal capacitor configured to hold the image signal voltage; and
a switching element with a control terminal connected to the scanning signal line, a first conductive terminal connected to the data signal line, and a second conductive terminal connected to the liquid crystal capacitor, and
the switching element is a thin-film transistor with a channel layer formed with an oxide semiconductor.

13. The display device according to claim 12, wherein the thin-film transistor is a channel-etched thin-film transistor.

14. The display device according to claim 13, wherein the oxide semiconductor is indium gallium zinc oxide.

15. The display device according to claim 14, wherein the oxide semiconductor is a crystalline oxide semiconductor.
